(19) United States
(12) Patent Application Publication
(10) Pub. No.: US 2006/0005046 A1
(43) Pub. Date: Jan. 5, 2006

(54) Secure firmware update procedure for programmable security devices

(75) Inventor: Laszlo Hars, Cranberry Township, PA (US)

Correspondence Address: Robert P. Lenart;Pietragallo, Bosick & Gordon, One Oxford Centre, 301 Grant Street, 38th Floor, Pittsburgh, PA, 15219, US

(73) Assignee: Seagate Technology LLC, Scotts Valley, CA (US)

(21) Appl. No.: 10/881,769

(22) Filed: Jun. 30, 2004

(51) Int. Cl. G06F 11/30

(52) U.S. Cl. 713/191

(57) ABSTRACT

A method of updating firmware in a programmable device comprises: downloading encrypted updated firmware to a programmable device, using a combination of previously installed firmware code and auxiliary data to produce a key, and using the key to decrypt the updated firmware.

### FIELD OF THE INVENTION

This invention relates to programmable devices and more particularly to methods for updating firmware in such programmable devices.

### BACKGROUND OF THE INVENTION

Many versions of firmware update files are made public by the creator of the firmware. A firmware update file could be modified to change the function of the target device or prevent its functioning. Unauthorized access to firmware update files must be prevented. Rogue firmware can be downloaded to change the function of the target device or prevent its functioning, or an older or incompatible firmware version can be downloaded, with known and exploitable problems or suboptimal performance.

Firmware files can be encrypted, however a cracked (decrypted) firmware download file could allow all devices of the same type to be attacked. From the cracked device, an attacker could learn enough information to attack all devices having the same type of firmware files.

Several prior software update procedures assume a live connection to a server or host, that allows for negotiating an encryption key, or establishing another form of secure communication.

There is a need for a method of updating firmware that reduces the probability of unauthorized access to the firmware, and which does not need to negotiate keys or to even be connected to a remote site.

### SUMMARY OF THE INVENTION

This invention provides a method of updating firmware in a programmable device, comprising: downloading encrypted updated firmware to a programmable device, using a combination of previously installed firmware and auxiliary data to produce a key, and using the key to decrypt the updated firmware.

### BRIEF DESCRIPTION OF THE DRAWINGS

FIGS. 1 and 2 are flow diagrams that illustrate the method of this invention.

### DETAILED DESCRIPTION OF THE INVENTION

Firmware update files can contain encrypted firmware code and auxiliary data. The auxiliary data can include data such as the manufacturer name or identification, the model number of the target device, the version number of the new firmware, the version numbers of the old firmware to be replaced, a nonce N (random number), a digital signature of the firmware code, and a range of firmware serial numbers.

The digital signature is some attached information, calculated by a function of the data to be signed and some secret information, the signing key, which is only known by the signer. Functions which are very difficult (practically impossible) to invert are called one-way functions. This means that even if an attacker knows a reasonable number of the values of the one-way function, the attacker still cannot learn anything about the function arguments. Secure signatures are calculated by one-way functions, which prevent an attacker from discovering the signing key from the signature and prevent the attacker from creating valid signatures without the signing key.

Nonces (Numbers used ONCE) are often used in security protocols. They make each message different, such that a recorded message cannot be replayed without breaking an appropriately designed cryptographic protocol. In the case of a firmware update, an attacker might have been able to steal or correctly guess the digest (hash) of a valid firmware. If the digest depends on a nonce, the attacker needs the digest of the old firmware for all possible nonces, which would be practically impossible to calculate and store.

The previously installed firmware code and auxiliary data from the updated firmware can be used to generate a key, K, which can be a one-way function of the auxiliary data and the digest (hash) of the firmware code currently in the device. When the updated firmware is downloaded, the previously installed firmware uses the key K to decrypt the updated firmware. If the previous firmware download happened securely, the firmware code is intact, and the key K will properly decrypt the updated firmware.

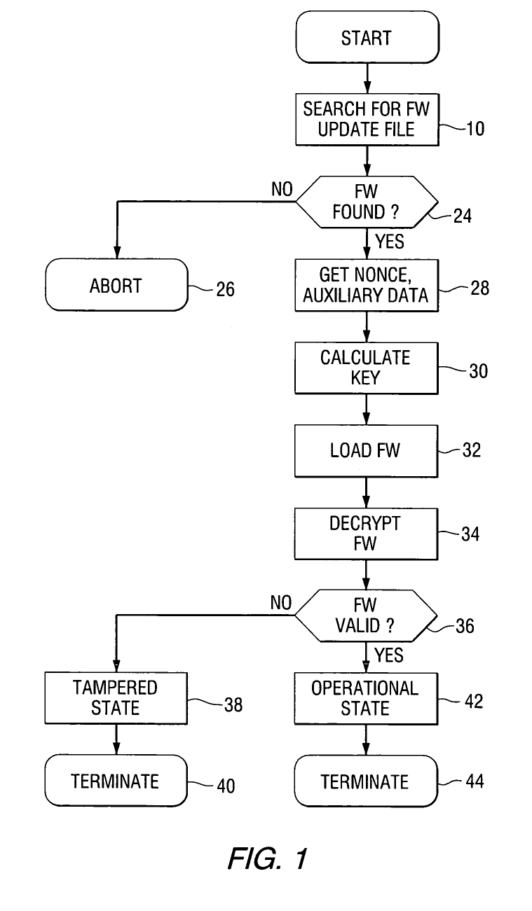

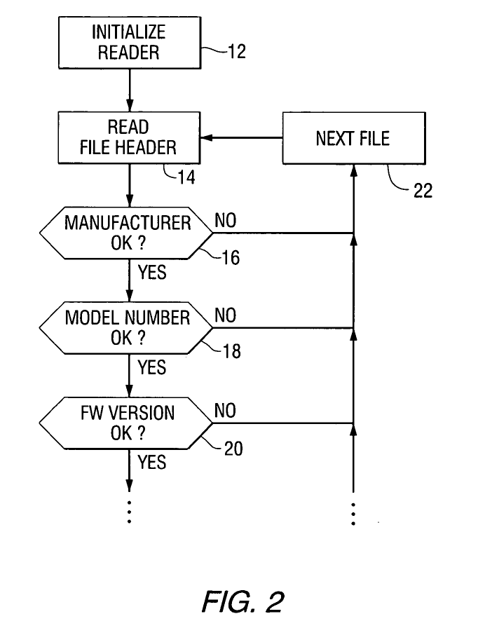

Referring to the drawings, FIGS. 1 and 2 are flow diagrams that illustrate the method of this invention. The new firmware can be supplied in several ways. For example, it might be available on a website, or it might be on a portable storage medium, such as a CD or DVD. Block 10 illustrates that the method begins by searching for a firmware update file. For example, files on a CD might be checked sequentially to find a potentially acceptable firmware update file.

The searching function is described in more detail in FIG. 2. To search for an appropriate firmware file, a reader would be initialized as shown in block 12. Block 14 shows that the file header of a possible updated firmware file would be read, and several tests can be performed to determine if the possible updated firmware appears to be appropriate. As illustrated in blocks 16, 18 and 20, the header information can be checked for various parameters such as manufacturer, model number, and firmware version. If any of these tests fails, the process can proceed to another firmware file as shown in block 22.

If an updated file is not found (block 24), the process is stopped (block 26). If an updated file is found, the updated file will include an unencrypted portion and an encrypted portion. The unencrypted portion of the updated file can include a nonce and other auxiliary information. The nonce and auxiliary data are retrieved by the programmable device from the unencrypted portion of the new firmware file (block 28).

Functions, which take an arbitrarily long input and calculate a fixed length output with a statistically uniform distribution, are called hash functions. There are many ways to define secure hash functions. For example directly, using the SHA-1 algorithm, or indirectly based on some feedback mode of a block cipher. The previously installed firmware uses the nonce and auxiliary data in combination with at least a portion of itself, (the previously installed firmware code) as inputs to a secure hash function to calculate a key (K) as shown in block 30.

The hash value can be calculated from the concatenation of all of the pieces of information, with possibly some of them altered by applying an exclusive OR (XOR) with a constant in a pre-specified manner, or in some other way known in the art. Some pieces of information could be repeated in the concatenated sequence, which forms the input of the hash function.

Then the new firmware is loaded (block 32) and decrypted (block 34) using the key, K. There should be an unchangeable part of the previously installed firmware (stored in read-only memory), which performs this decryption and loading of the new firmware into the memory of the device. For the decryption of the new firmware only the key K is needed, which was calculated using the old firmware code. The decryption-loading function remains intact during the process, when part of the old firmware gets overwritten.

One of the main purposes of this encryption is the protection of the firmware code, which could contain secrets, like keys, or intellectual property (algorithms, data structures etc.). Neither the previously distributed old firmware code nor the new firmware code is accessible unencrypted, and the existing firmware code is contained in a nonvolatile memory of the device, which cannot be accessed outside of the device, so an attacker cannot compute the key K.

Since the key is dependent on a nonce and/or some hardware related information, it is different between batches of devices and for different nonces on the distribution media. In addition, since the encryption key is dependent on the firmware code, an attacker needs the code to be able to compute the key, but the code is kept secret all the time.

If an attacker were to guess the key (for long enough keys it is a very unlikely event), he might be able to decrypt the new firmware for a particular device. However, he still cannot produce a valid, digitally signed rogue firmware version to be downloaded to any other device. Thus the knowledge of a single key does not help an attacker to find other keys, so future firmware codes are still secure.

The old firmware and hardware related information prevents downloading of firmware versions not intended for that particular combination of hardware and existing firmware. Since the key is dependent on a nonce, a short fingerprint (hash) of the firmware code may not be sufficient for computing the key. The portion of the existing firmware used in the key generation should be sufficiently long so that it would be difficult to correctly guess the hash value, but short enough so that a fast calculation of the key can be performed.

When the new firmware update file is generated in the factory, it is digitally signed to assure integrity. A range of serial numbers can be chosen by the creator of the firmware. For all legitimate earlier firmware code versions the manufacturer chooses a certain number of random nonces. For each combination of old code and a chosen nonce, a corresponding encryption key is computed and the new firmware file is encrypted with it. The resulting encrypted firmware can be stored on the distribution media with the nonce, and other auxiliary information such as the old and new firmware version numbers, and hardware information (for example, a range of serial numbers). The process is repeated for all valid ranges of serial numbers. The creator knows all of the previous firmware code versions (he compiled them earlier), and all the valid hardware related information (for example, serial numbers).

Referring again to FIG. 1, the decrypted firmware can be checked for validity (block 36). Some functionality of the firmware should be unchangeable. The unchangeable portion of the firmware is referred to as a persistent part of the firmware. The unchangeable or persistent portion of the previously installed firmware can be used to check the validity of the new firmware. In one mode of operation, the invention can use encryption, not hashing, for the integrity check, but any other integrity check method known in the art can be applied as well. For example a well-known digital signature technique, or another technique, can be used for integrity verification, such as encryption of identification information (ID) or some commonly known data. If the decryption produces this ID data, the firmware update file is valid. This implicitly assumes that some feedback mode of encryption is used (e.g. cyclic block chaining, CBC), which prevents attacks by attaching a block of data with the encrypted identification information.

If the decrypted firmware is not valid, then the device is deemed to be in a tampered state (block 38), and the process is terminated (block 40). This decision is enforced by the non-changeable firmware part. If the decrypted firmware is valid, then it is used in the device (block 42) and the process is terminated (block 44).

This invention permits individualized update files for groups of devices, so that a successful attack (decrypting) of one firmware version, and illicitly modifying the code, does not compromise all other devices. The firmware digest for each device is different and unknown to the attacker, so other devices don't accept rogue firmware code derived from an attacked device. Only a few versions have to be provided by the manufacturer, dependent on the firmware code, so unintended targets with identification information from a different range, and devices that do not have a full copy of the old firmware, cannot calculate the decryption key dependent on a nonce. Different copies (batches) of the firmware update files are encrypted differently. The files may be encrypted with a key derived from a range of device serial numbers, an attached nonce, the associated digest of the current firmware in the target device, and from possibly other information. Encrypted update files are protected from any change in the update firmware code that makes it inconsistent with the signature (for example the encrypted ID will be invalid after a decryption with the wrong key).

The firmware used in this invention performs a new function, that is, it allows its own replacement. Upon request, the previously existing firmware checks the authenticity of the new code. Public key signature schemes can be used. These use a secret signing key and a public verification key. Knowing the public key and/or any number of signatures does not enable an attacker to compute the private key or produce a valid signature. Only the person who knows the secret private key can create a valid signature, but anybody can verify the validity of the signature using the public verification key. In the case of firmware update files, the signing key can be used when the new firmware files are created, and the old firmware can use the public verification key included in its code to verify the authenticity of the new firmware.

In case the changeable part of the firmware code gets damaged, a download gets interrupted, or an error occurs during the transfer of the code, the device should be able to revert to its previous state. If reversion to the previous state is not possible, an initialization mode can be activated, where the device accepts firmware code encrypted with a key dependent on its unique serial number. This version of the firmware download file must be fully personalized by the manufacturer, that is, it has to be dependent on the device serial number. This firmware version cannot be used for any other device, but it needs to be created for that particular device, which is costly. Therefore, this scheme would only be used in an emergency situation, when the firmware of a device gets corrupted.

Under normal circumstances, a firmware update performed in accordance with this invention would not require any online infrastructure (customer service representatives, websites, secure online computers, certification authority . . . ). The firmware update files can be published on websites, or burned and distributed on CD ROMs, etc. Extensions and revocation lists can be distributed with newer versions of the firmware and among external entities that the devices communicate with. This helps to exclude hacked devices from communicating with others.

This invention uses (among things) the last stored firmware code, which is a changeable piece of information. The invention can be applied to any device that includes firmware. In one example, the invention can be applied to a processor used in a disc drive controller. However, the invention can be applied to any device containing firmware that can be updated.

While the invention has been described in terms of several examples, it will be apparent to those skilled in the art that various changes can be made to the disclosed examples without departing from the scope of the invention as set forth in the following claims.

What is claimed is:

1. A method of updating firmware in a programmable device, the method comprising:
downloading encrypted updated firmware to a programmable device;
using a combination of previously installed firmware and auxiliary data to produce a key; and
using the key to decrypt the updated firmware.

2. The method of claim 1, wherein the key comprises a one-way function of the auxiliary data and at least a portion of the previously installed firmware.

3. The method of claim 1, wherein the key comprises a hash function of at least a portion of the previously installed firmware.

4. The method of claim 1, wherein a portion of the previously installed firmware is unchangeable.

5. The method of claim 4, further comprising:
using the unchangeable portion to decrypt the decrypted updated firmware.

6. The method of claim 4, further comprising:
using the unchangeable portion to validate the decrypted updated firmware.

7. The method of claim 1, wherein the previously installed firmware is stored in a non-volatile memory that is not accessible from outside of the programmable device.

8. The method of claim 1, wherein the auxiliary data relates to the updated firmware.

9. The method of claim 1, wherein the auxiliary data relates to the programmable device.

10. The method of claim 1, wherein the auxiliary data includes one or more of:
a manufacturer's identification;
a model number of a target device;
a version number of the updated firmware;
a version number of the previously installed firmware;
a nonce;
a digital signature; and
a range of serial numbers.

11. The method of claim 1, further comprising:
checking validity of the updated firmware.

12. The method of claim 1, further comprising:
using a public key to check the validity of the updated firmware.

13. The method of claim 1, further comprising:
using the previously installed firmware if the step of using the key to decrypt the updated firmware is unsuccessful.
